(19) United States
(12) Patent Application Publication
(10) Pub. No.: US 2014/0154998 A1
(43) Pub. Date: Jun. 5, 2014

(54) Transmit Adaptation Responsive to Signal Transformation

(71) Applicant: Broadcom Corporation, Irvine, CA (US)

(72) Inventors: Bongseok Park, Pleasanton, CA (US); Sriraman Dakshinamurthy, San Jose, CA (US); Robert Gustav Lorenz, Menlo Park, CA (US)

(21) Appl. No.: 13/922,861

(22) Filed: Jun. 20, 2013

Related U.S. Application Data
(60) Provisional application No. 61/804,536, filed on Mar. 22, 2013.
(60) Provisional application No. 61/732,780, filed on Dec. 3, 2012.

(51) Int. Cl. H04W 24/02

(52) U.S. Cl. CPC H04W 24/02
USPC 455/69

(57) ABSTRACT

A communication device, such as a smart phone, monitors signal transformations and adapts its transmit chain in response. The transformations may include the effect of load angle and load magnitude on a signal prepared for transmission through an antenna. In response to the transformations, the communication device may, for example, determine a new shaping table, and replace an existing shaping table with the new shaping table. The communication device uses the shaping table to generate an envelope signal for an envelope tracking power supply, and the new shaping table may be selected to provide, e.g., power saving operation given the current load angle and load magnitude.

### CROSS REFERENCE TO RELATED APPLICATIONS

This application claims priority to U.S. Provisional Application Ser. No. 61/732,780, filed 3 Dec. 2012, which is incorporated by reference in its entirety. This application also claims priority to, and incorporates by reference, U.S. Provisional Application Ser. No. 61/804,536, filed 22 Mar. 2013.

### TECHNICAL FIELD

This disclosure relates to signal transmission. This disclosure also relates to the transmit circuitry in user equipment such as cellular telephones and other devices.

### BACKGROUND

Rapid advances in electronics and communication technologies, driven by immense customer demand, have resulted in the widespread adoption of mobile communication devices. The extent of the proliferation of such devices is readily apparent in view of some estimates that put the number of wireless subscriber connections in use around the world at over 85% of the world's population. Furthermore, past estimates have indicated that (as just three examples) the United States, Italy, and the UK have more mobile phones in use in each country than there are people even living in those countries. Improvements in wireless communication devices, particularly in their ability to reduce power consumption, will help continue to make such devices attractive options for the consumer.

### BRIEF DESCRIPTION OF THE DRAWINGS

The innovation may be better understood with reference to the following drawings and description. In the figures, like reference numerals designate corresponding parts throughout the different views.

FIG. 1 shows an example of user equipment that includes a transmit and receive section.

FIG. 2 is an example of a transmit and receive section.

FIG. 3 shows an example mapping of load characteristics to shaping tables.

FIG. 4 shows an example of determining a new shaping table data set in response to load characteristics.

FIG. 5 shows logic for making modifications to a shaping table based on load characteristics.

### DETAILED DESCRIPTION

The discussion below makes reference to user equipment. User equipment may take many different forms and have many different functions. As one example, user equipment may be a 2G, 3G, or 4G/LTE cellular phone capable of making and receiving wireless phone calls, and transmitting and receiving data. The user equipment may also be a smartphone that, in addition to making and receiving phone calls, runs any number or type of applications. User equipment may be virtually any device that transmits and receives information, including as additional examples a driver assistance module in a vehicle, an emergency transponder, a pager, a satellite television receiver, a networked stereo receiver, a computer system, music player, or virtually any other device. The techniques discussed below may also be implemented in a base station or other network controller that communicates with the user equipment.

As an introduction to the techniques described in more detail below, the user equipment (UE) may include a shaping table, a feedback receiver, and a controller in communication with the shaping table and the feedback receiver. The controller is operable to obtain an outgoing signal for transmission, and obtain a sensed signal from the feedback receiver. The sensed signal arises from transmission of the outgoing signal (after, e.g., upconversion and amplification). The controller determines a transformation to the outgoing signal exhibited in the sensed signal, and determines a modification to the shaping table after determining the transformation.

The modification may be, as one example, a new input/output relationship for the shaping table. The modification may be made, for instance, by applying an offset to, or replacing, one or more data points in an existing shaping table, by replacing the entire existing shaping table with a new shaping table, or in other manners. The transformation may be a gain, a rotation, or both. In that respect, the controller may determine a load angle and a load magnitude that results in the transformation. The controller may then implement a particular shaping table chosen according to the load angle and the load magnitude. The particular shaping table may be one that helps the system achieve a certain amount of power saving, by recognizing and taking account of the effects that the particular load angle and load magnitude have on transmission of the outgoing signal.

In more detail, a system may include a baseband controller, and a shaping table in communication with the baseband controller. The shaping table operable to modify a transmit signal to provide envelope tracking signals characterized by a signal envelope. The system also includes an envelope tracking power supply that receives the envelope tracking signals and outputs a power supply voltage signal that approximates the signal envelope. A power amplifier receives the power supply voltage signal and drives a transmit antenna. In addition, a feedback receiver is coupled to the transmit antenna, e.g., with a directional coupler.

The baseband controller is configured to provide the transmit signal to the shaping table and obtain, from the feedback receiver, sensed signal samples arising from transmission of the input signal through the transmit antenna. The baseband controller analyzes the sensed signal samples to determine a load angle and load magnitude affecting transmission of the input signal through the transmit antenna and adapt the shaping table to account for the load angle and the load magnitude.

The baseband controller may adapt the shaping table by replacing the shaping table with a different input/output relationship. In some implementations, the baseband controller searches a library of input/output relationships prepared for different load angles and load magnitudes, to locate the particular input/output relationship used to adapt the shaping table. Note that the library may store entire shaping tables, portions of shaping tables that may, for instance, replace a baseline shaping table, offsets to specific data points of a baseline shaping table, or other modifications. The baseline shaping table may be one used for nominal load characteristics, such as a 50 ohm load as seen by the PA 206. Accordingly, searching the library may result in several different possible types of modifications to the shaping table 216, and the modification need not be a complete replacement of an existing shaping table. One effect of the adaptation is that as the load characteristics change, so may the output of the ET power supply 220, due to modifications to the shaping table 216 responsive to the load characteristics.

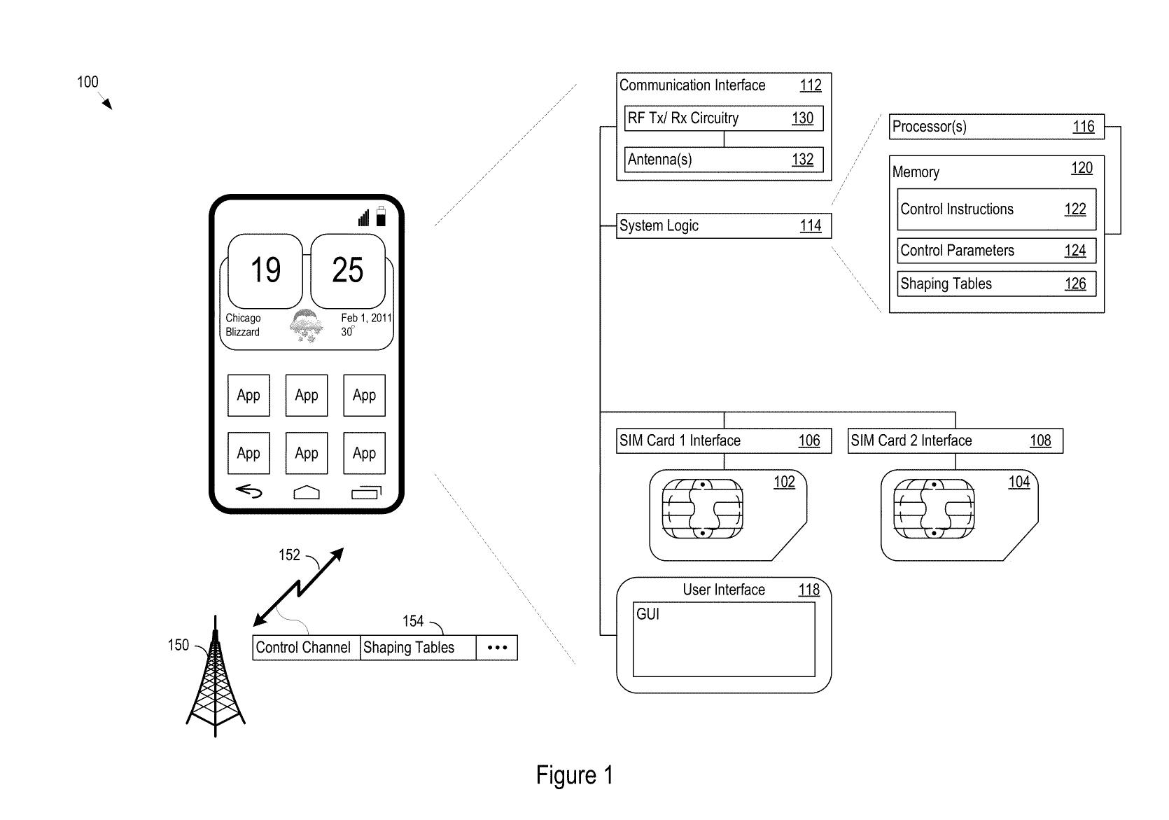

FIG. 1 shows an example of user equipment (UE) 100 in communication with a network controller 150, such as an enhanced Node B (eNB) or other base station. In this example, the UE 100 supports one or more Subscriber Identity Modules (SIMs), such as the SIM1 102 and the SIM2 104. An electrical and physical interface 106 connects SIM1 102 to the rest of the user equipment hardware, for example, through the system bus 110. Similarly, the electrical and physical interface 108 connects the SIM2 to the system bus 110.

The user equipment 100 includes a communication interface 112, system logic 114, and a user interface 118. The system logic 114 may include any combination of hardware, software, firmware, or other logic. The system logic 114 may be implemented, for example, in a system on a chip (SoC), application specific integrated circuit (ASIC), or other circuitry. The system logic 114 is part of the implementation of any desired functionality in the UE 100. In that regard, the system logic 114 may include logic that facilitates, as examples, running applications; accepting user inputs; saving and retrieving application data; establishing, maintaining, and terminating cellular phone calls or data connections for, as one example, Internet connectivity; establishing, maintaining, and terminating wireless network connections, Bluetooth connections, or other connections; and displaying relevant information on the user interface 118. The user interface 118 may include a graphical user interface, touch sensitive display, voice or facial recognition inputs, buttons, switches, speakers and other user interface elements.

In the communication interface 112, Radio Frequency (RF) transmit (Tx) and receive (Rx) circuitry 130 handles transmission and reception of signals through the antenna(s) 132. The communication interface 112 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or through a physical (e.g., wireline) medium.

As one implementation example, the communication interface 112 and system logic 114 may include a BCM2091 EDGE/HSPA Multi-Mode, Multi-Band Cellular Transceiver and a BCM59056 advanced power management unit (PMU), controlled by a BCM28150 HSPA+ system-on-a-chip (SoC) baseband smartphone processor or a BCM25331 Athena™ baseband processor. These devices or other similar system solutions may be extended as described below to provide the additional functionality described below. These integrated circuits, as well as other hardware and software implementation options for the user equipment 100, are available from Broadcom Corporation of Irvine California.

The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interface 112 may support transmission and reception under the 4G/Long Term Evolution (LTE) standards. The techniques described below, however, are applicable to other communications technologies whether arising from the 3rd Generation Partnership Project (3GPP), GSM® Association, Universal Mobile Telecommunications System (UMTS), High Speed Packet Access (HSPA)+, or other partnerships or standards bodies.

The system logic 114 may include one or more processors 116 and memories 120. The memory 120 stores, for example, control instructions 122 that the processor 116 executes to carry out any of the processing or control functionality described below, operating in communication with the circuitry in the communication interface 112. For example, the system logic 114 may reprogram, adapt, or modify parameters or operational characteristics of the logic in the communication interface 112 and in the system logic 114 itself. The system logic 114 may make adaptations to, as a specific example, a shaping table implemented, whether implemented in or by the system logic 114 or in or by the communication interface 112.

The control parameters 124 provide and specify configuration and operating options for the control instructions 122. As will be explained in more detail below, the memory 120 may also store a library of data sets that represent shaping tables 126. The UE 100 may determine a modification to an existing shaping table (e.g., by reprogramming the shaping table with another data set from the library) in response to transformations determined in a transmitted signal. For instance, the control instructions 122 may determine load characteristics such as load angle and load magnitude that affect the transmitted signal, and modify the shaping table to account for the load characteristics.

As noted above, the UE 100 is in communication with the network controller 150 over one or more control channels 152. The network controller 150 sends messages to the UE 100 over the control channels 152. The messages may include operating parameters 154, such as power control parameters, bandwidth allocation parameters, and other operating parameters. In some implementations, the network controller 150 may send new shaping tables to the UE 100 for entry into the library of shaping tables 126. The new shaping tables may, for instance, be mapped or indexed in the library to specific load conditions that the UE 100 may experience.

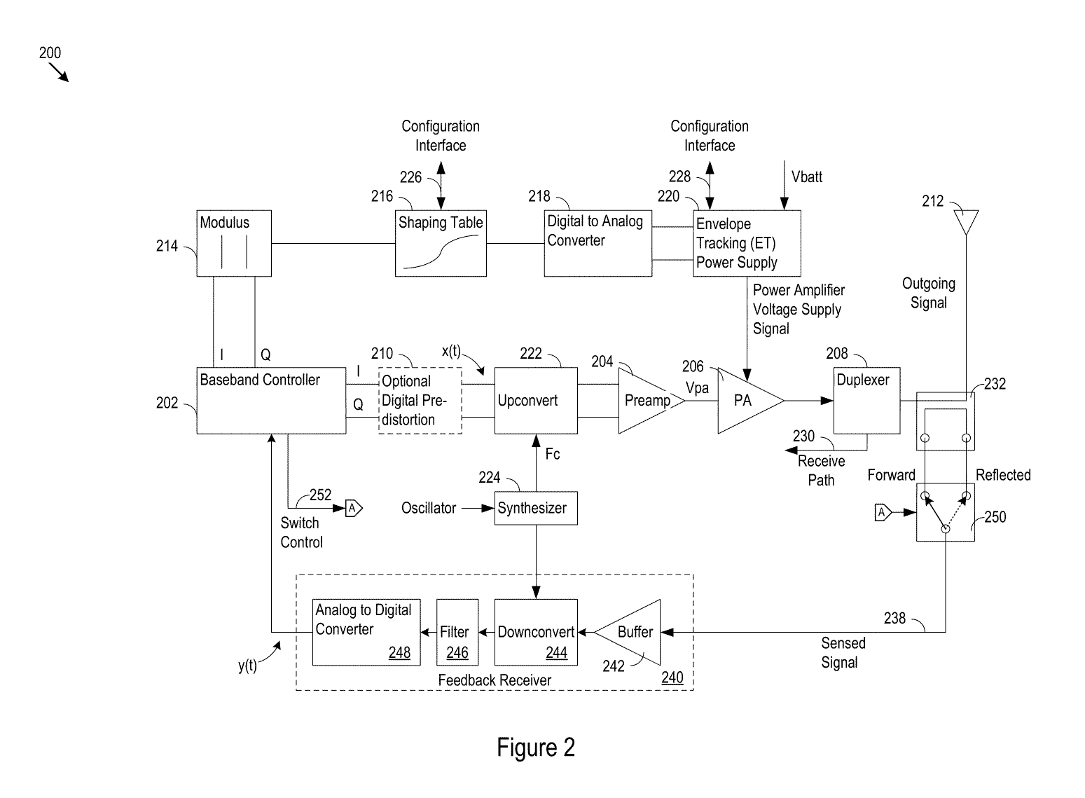

FIG. 2 shows an example of transmit/receive logic 200 that may be present in the user equipment 100. The logic 200 may include a baseband controller, RF IC, power amplifier, and envelope tracking power supply, and other circuitry. Accordingly, the logic 200 may include one or more portions of the Tx/Rx circuitry 130 and the system logic 114.

The logic 200 shown in FIG. 2 includes a baseband controller 202, a preamplifier 204, a power amplifier (PA) 206, and a duplexer 208. Pre-distortion logic 210 is optionally present, and may modify the input signal samples from the baseband controller prior to generation of the preamplifier output signal to the PA 206. An upconversion section 222 prepares the input signal samples for transmission. The upconversion section 222 may center the signal to be transmitted at a particular center frequency Fc. Different center frequencies for transmitting and for receiving may be specified over a control channel by a base station (for example), and internally generated by a frequency synthesizer 224 for upconversion and downconversion in the logic 200. The upconversion section 222 may implement a processing flow for the input signal samples that includes, as examples, a pre-emphasis or baseband gain stage, I and Q DACs, analog filters, and mixers for upconversion to Fc. Pre-amplification by the pre-amplification stage 204, and power amplification by the PA 206 may follow.

The duplexer 208 may implement a transmit/receive switch under control of the system logic 114. In one switch position, the duplexer 208 passes amplified transmit signals through the antenna 212. In a different switch position, the duplexer 208 passes received signals from the antenna 212 to the receive path 230 for further processing.

The baseband controller 202 may be part of the system logic 114. The baseband controller 202 provides, e.g., inphase/quadrature (I/Q) input signal samples to the modulus logic 214. The modulus logic 214 may output the absolute value (e.g., the square root of I squared plus q squared) of the input signal to a shaping table 216. The shaping table 216 maps input values to output values in a linear or non-linear manner. The output of the shaping table 216 feeds the digital to analog converter (DAC) 218. In turn, the DAC 218 outputs the envelope of the input signal as modified by the shaping table to the envelope tracking (ET) power supply 220. Said another way, the shaping table 216 implements a non-linear mapping between the modulus of the signal to be transmitted and the voltage that appears at the output of the DAC 218, to which the ET switcher is responsive.

The shaping table 216 may be implemented in many ways. For example, the shaping table may be a lookup table implemented in software or hardware, as part of the baseband controller 202, or as a separate circuit. The shaping table 216 may include, for instance, 64 or 128 table data set values that map input signal values to output signal values. The shaping table implementation may perform linear or non-linear interpolation between specific data set values, for any input signal value that does not exactly correspond to one of the sample points having a specific data set value in the shaping table 216. In other implementations, the shaping table 216 may be implemented as program instructions that calculate the output value as a function of input signal value according to any desired input to output relationship curve.

Configuration interfaces 226 and 228, e.g., serial or parallel data interfaces, control pins, or other interfaces, may be provided to configure the shaping table 216 and ET 220, or other parts of the logic 200. The configuration interfaces 226 and 228 may be MIPI Alliance specified interfaces or other types of interfaces.

An envelope tracking power supply (ET) 220 receives the envelope signal from the DAC 218. The ET 220 may output a PA power supply voltage signal that follows the envelope signal, plus a preconfigured amount of headroom. The PA power supply voltage signal provides power to the PA 206 for driving the antenna 212 with the transmit signal.

The logic 200 may support a wide range of output powers. The output power employed at any particular time may be specified by a base station, for example. In some implementations, the logic 200 may generate output powers at the antenna 212 of 23 dBm. As noted above, the duplexer 208 may separate the transmit path and receive path, and in doing so introduces some power loss, typically on the order of 3 dBm. Thus, to achieve 23 dBm output power at the antenna 212, the PA 206 produces approximately a 26 dBm signal. Doing so, however, consumes a significant amount of power due to inefficiencies in the components of the logic 200. In particular, the PA 206 itself may be on the order of 40% efficient. Given these losses, certain techniques are described below that result in significant power savings for the device 100.

Specifically, the logic 200 may implement reprogramming of the shaping table 216 in response to load conditions experienced by the logic 200, and in particular by the PA 206. The reprogramming carried out (e.g., the particular shaping table data set programmed into the shaping table) may vary according to load angle and load magnitude. These load characteristics affect the transmit signal, causing specific types of transformations that manifest themselves in the actually transmitted signal.

To facilitate analysis of the load characteristics, the logic 200 includes a directional coupler 232. The directional coupler 232 is part of a sensed signal path 238 that provides a sensed signal input to a feedback receiver 240. The directional coupler 232 is responsive to transmission by the PA 206 through the antenna 212. Specifically, the directional coupler 232 couples a portion of the transmitted signal onto the sensed signal path 238 for processing by the feedback receiver 240. In other words, the sensed signal arises from transmission of the outgoing signal driven through the antenna 212.

The feedback receiver 240 may be implemented in many different ways. For example, the feedback receiver 240 may include an amplifier or buffer 242 and a downconversion section 244. The feedback receiver 240 may also include a filter 246 and an ADC 248. The ADC 248 outputs digital signal samples, y(t), of the sensed signal obtained by the directional coupler 232. The digital signal samples provide a measurement of the outgoing signal, which is the actual signal transmitted through the antenna 212. The baseband controller 202 may then analyze y(t) with respect to the desired transmit signal, x(t).

The load characteristics are influenced by several factors. Antenna implementations are generally a compromise of efficiency, size, and support for many different transmit and receive bands. Further, when an individual holds a handset, the hand tends to influence the near field of the antenna, and may effectively detune or change the tuning of the antenna. Thus, due to antenna imperfections, near field effects, design compromises, presence of the duplexer 208, uncalibrated effects in tuning the antenna, and other effects, the load seen by the PA 206 may often change, and may often be something other than a matched 50 ohms.

When the load seen by the PA 206 is not matched to 50 ohms (or some other nominal expected impedance for which the PA 206 is designed), some of the energy cannot be delivered through the antenna 212. The energy that is not delivered to the antenna 212 reflects back towards the PA 206. The reflected and forward waves interact and result in standing wave patterns. The standing wave patterns result in increased RF energy loss and, distortion due to reflected power. For these reasons and others, the logic 200 may determine the load characteristics (e.g., the complex impedance into the antenna 212), and adapt the shaping table 216 to accommodate the load characteristics.

The adaptation by include implementing a shaping table that changes the envelope of the tracking voltage and that may, for example, result in reduced power consumption by the PA 206 given the current load characteristics. The amount of power supply voltage to the PA 206 needed to meet output requirements, such as a desired output power and spectral masking, is generally a function of load angle and load magnitude. As one example, larger reflections due to the load characteristics may require additional voltage supply to the PA 206 to meet the output requirements, and the extent to which additional voltage is required is a function of the load angle.

The baseband controller 202 may determine the load characteristics, and specifically the load angle and magnitude, as set forth below.

y(t) represents the sampled sensed signal, and may be obtained by using the switch control 252 to change the switch 250 to a feedback position (e.g., from a forward position to a reflected position). Any number of sample points may be taken for use in the analysis. There may be, for example, 50 us worth of sample points taken, at a 200 MHz sample rate, for a total of 1,000 sample points:

y(t)=[y₁|y₂|y₃| . . . |yₙ]

x(t) represents the transmit signal that was intended for transmission as the output signal from the antenna 212:

x(t)=[x₁|x₂|x₃| . . . |xₙ]

Note that each sample of x(t) and y(t) may be 2×1 entries representing Inphase and Quadrature components of the respective signals. The baseband controller 202 models the transformation of x(t) to arrive at y(t). In particular, the model may be:

y=Ax

where A represents a gain, g, and rotation:

$$\begin{matrix}A = g [ \begin{matrix}cos ( θ ) & - sin ( θ ) \\ sin ( θ ) & cos ( θ )\end{matrix} ] \\ = gU ( θ )\end{matrix}$$

where:

U:□→□^{2×2}

according to

$$U ( θ ) = [ \begin{matrix}cos ( θ ) & - sin ( θ ) \\ sin ( θ ) & cos ( θ )\end{matrix} ]$$

Then

yx^{T}=Axx^{T}

Expressed in an alternate notation:

R_{yx}=ARₓₓ

Note that the baseband controller 202 may accumulate the samples in place in a memory efficient way:

R_{yx}=Σᵢ₌₁ⁿyᵢxᵢ^{T}

and

Rₓₓ=Σᵢ₌₁ⁿxᵢxᵢ^{T}

To determine A, the baseband controller 202 may then evaluate:

R_{yx}Rₓₓ⁻¹=A

Knowing A, the baseband controller 202 may determine the gain or load magnitude using the following relationship:

AA^{T}≈gU(θ)U^{T}(θ)g=g²I

The baseband controller 202 may estimate the load magnitude or gain according to:

ĝ=½Tr(\sqrt{AA^{T}})

and the load angle according to:

$$\hat{θ} = \frac{∠ ( {A}_{11} + j {A}_{21} ) + ∠ ( {A}_{22} - j {A}_{12} )}{2}$$

where Tr denotes the trace operator, that is, the sum of the diagonal elements of a matrix. Another example of how to determine load angle and magnitude is given in U.S. Patent Publication 2012 0270511 A1, titled Closed Loop Power Control for a Wireless Transmitter. Other techniques may also be used to determine the load characteristics.

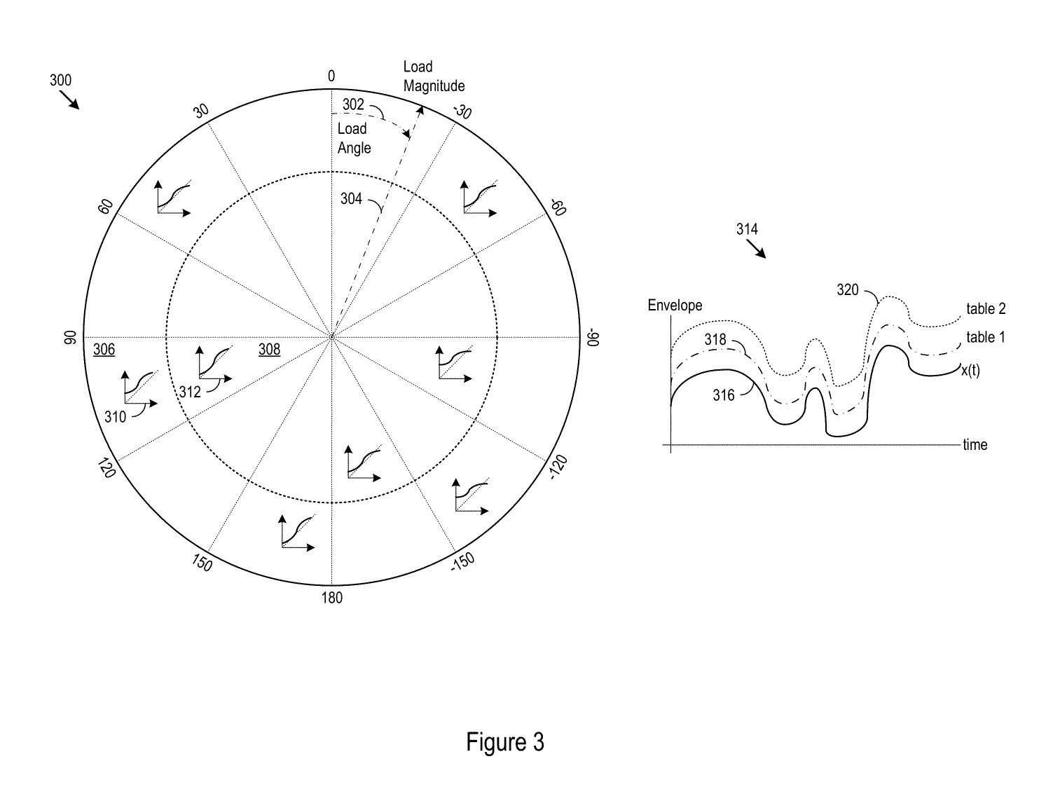

FIG. 3 shows an example mapping 300 of load characteristics to shaping tables. In particular, FIG. 3 shows one way in which a load angle 302 and a load magnitude 304 parameterize a search space. In the example of FIG. 3, two (2) load magnitudes and twelve (12) load angles define twenty-four (24) different sectors (e.g., the sector 306 and the sector 308) that map to shaping tables (e.g., the shaping table 308 and the shaping table 312). Different sectors may map to the same or different shaping table. There may be additional, fewer, or different divisions of load angle and magnitude, resulting in a wide range of potentially different numbers of sectors, and corresponding shaping tables. In addition, the search space may be parameterized differently, such as by output power, load angle, or SWR, or any combination of those parameters. In other words, the search space may take into consideration output power, SWR, as well as other parameters for locating the modification to the shaping table 216. The modifications in the search space may be selected to achieve a particular goal. For example, the goal may be minimizing power consumption over a selected set of components (e.g., the logic 200) in the UE 100. As another example the goal may be to minimize power consumption over a selected set of components while meeting a specified adjacent channel leakage ratio (ACLR).

FIG. 3 also shows an example 314 of adjusting the voltage supply signal to the PA 206 responsive to load. The envelope 316 of the transmit signal x(t) is shown. Also shown is the voltage supply signal 318 generated by the ET power supply 220 for a particular shaping table. Note that the voltage supply signal 318 provides a configured amount of headroom above the envelope of the transmit signal 318. As noted above, the load characteristics may influence the difficulty or the ease with which the PA 206 drives the antenna 212 to obtain the required output power (e.g., 23 dBm). Thus, for example, the load characteristics make it more difficult for the PA 206 to drive the load (e.g., when there are strong reflections due to a load impedance less than 50 ohms). In that case, the system may adapt the shaping table to provide additional power to the PA 206 by modifying the shaping table 216. FIG. 3 shows a voltage supply signal 320 that provides even more headroom for the PA 206, to allow the PA 206 additional power with which to drive the load. Similarly, when the load characteristics make it easier for the PA 206 to drive the load, the shaping table 216 may change to reduce the amount of power supplied to the PA 206.

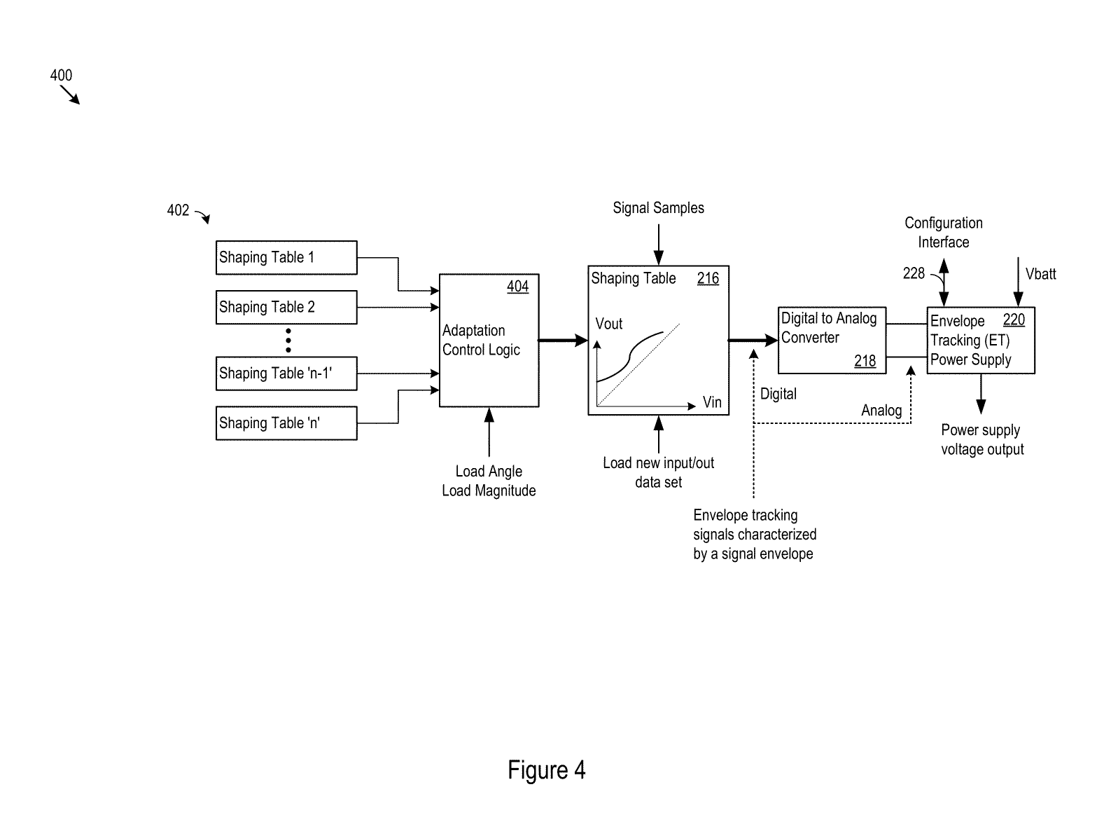

FIG. 4 shows another view of logic 400 for determining a new shaping table data set in response to measured load characteristics. A library 402 of shaping tables provides multiple shaping table options, for any desired combination of load angle and load magnitude. The shaping tables may be determined in advance by computer simulation as those shaping tables that provide, e.g., power saving benefits when the specific load characteristics are detected by the baseband controller 202. The simulation may sweep over any desired combination of load angle and magnitude, to find the shaping tables that result in meeting a desired goal, such as providing the lowest power consumption for any given combination of load angle and load magnitude. The library 402 may provide, for example, a different shaping table at any particular granularity of the parameters of the search space, such as the granularity shown in FIG. 3 for the search space 300.

The adaptation control logic 404 accepts as inputs the load characteristics, e.g., the load angle and the load magnitude. The adaptation control logic 404 may be implemented in hardware, software, or both to determine, given the inputs, how to configure the logic 200 to achieve a desired result (e.g., power saving, given the current load characteristics). To that end, the adaptation control logic 404 may select, given the current load characteristics, a shaping table from the library 402 that achieves the desired result. The desired result may be consuming the least amount of energy, for example, given the current load characteristics, or may be reducing power consumption by more than a threshold amount, given the current load characteristics.

When the adaptation control logic 404 will modify the shaping table 216, the adaptation control logic 404 first obtains the new shaping table from the library 402. The adaptation control logic 404 then reprograms the shaping table 216 with the input/output relationship represented by the new shaping table. As examples, the adaptation control logic 404 may perform the reprogramming by replacing lookup table data set values in non-volatile memory space reserved for the shaping table, or by replacing a calculation function in memory with a new function. The new shaping table then outputs envelope tracking signals characterized by a signal envelope for the DAC 218 which feeds the ET power supply 220. The power supply voltage output of the ET power supply 220 may then result in, for example, more power efficient operation given the current load characteristics, than if the shaping table 216 were not modified.

In other implementations, the system (e.g., the control logic 404 or baseband controller 202) may exercise additional control over the shaping table responsive to the load characteristics. For example, the load characteristics show that the transmit section cannot meet the desired output power (e.g., due to excessive standing wave ratios) without detrimental effects. In that case, the control logic 404 may adapt the shaping table to limit the output power available to the PA 206, as opposed to allowing the output power to increase to the level needed to overcome the load characteristics. Constraining the adaptation of the shaping table in this manner may then avoid the generation of significant undesired spectral emissions.

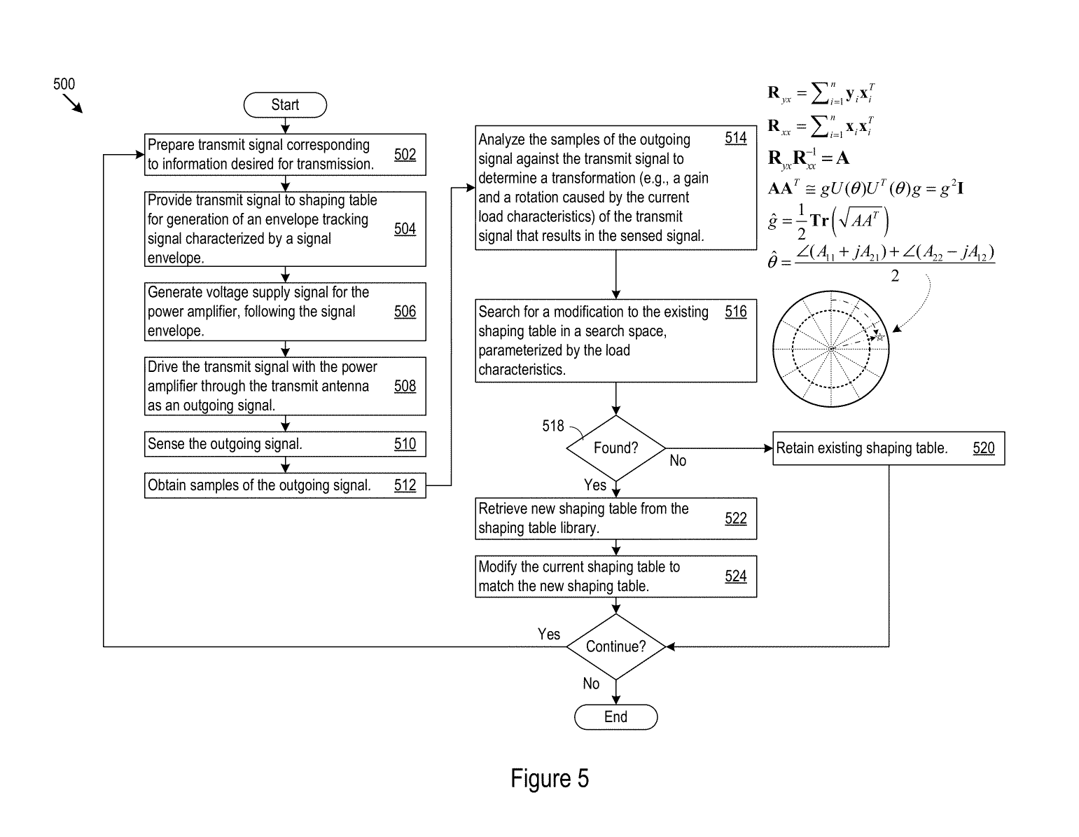

FIG. 5 shows logic 500 for making modifications to a shaping table based on load characteristics, such as load angle and load magnitude. The logic 500 may be implemented in one or more software layers in the UE 100, in software and firmware, for example as part of the control instructions 122. The logic 500 prepares a transmit signal (502). The transmit signal may represent the desired information that the UE 100 will transmit, whether part of a data stream for, e.g., Internet access, or for a cellular voice call.

The logic 500 provides the transmit signal, x(t), to a shaping table for generation of an envelope tracking signal characterized by a signal envelope (504). The ET power supply 220 generates a voltage supply signal for the power amplifier, following the signal envelope (506). The power amplifier drives the transmit signal (after, e.g., upconversion and amplification) through the transmit antenna 212 as an outgoing signal (508).

The outgoing signal is sensed, e.g., through the directional coupler 232 (510). The logic 500 may then obtain samples, y(t), of the outgoing signal from the feedback receiver 240 (512). The logic 500 may then analyze the samples of the outgoing signal against the transmit signal to determine a transformation of the transmit signal that results in the sensed signal (514). The transformation may be a gain and a rotation caused by the current load characteristics, for example.

Given the load characteristics, the logic 500 may search for a modification to the existing shaping table (516), such as a new shaping table to replace the existing shaping table. To that end, the logic 500 may search a search space parameterized by load angle and load magnitude, or other load characteristics. If a new shaping table is not found (518), then the logic 500 may retain the existing shaping table in place (520).

Otherwise, if the logic 500 does locate a new shaping table (518), then the logic 500 may retrieve the new shaping table from the shaping table library (522). The logic 500 then modifies the existing shaping table to match the new shaping table (524). For example, the logic 500 may replace all of, or part of, the existing shaping table with a modification reflected in the new shaping table.

The methods, devices, and logic described above may be implemented in many different ways in many different combinations of hardware, software or both hardware and software. For example, all or parts of the system may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. All or part of the logic described above may be implemented as instructions for execution by a processor, controller, or other processing device and may be stored in a tangible or non-transitory machine-readable or computer-readable medium such as flash memory, random access memory (RAM) or read only memory (ROM), erasable programmable read only memory (EPROM) or other machine-readable medium such as a compact disc read only memory (CDROM), or magnetic or optical disk. Thus, a product, such as a computer program product, may include a storage medium and computer readable instructions stored on the medium, which when executed in an endpoint, computer system, or other device, cause the device to perform operations according to any of the description above.

The processing capability of the system may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library, such as a shared library (e.g., a dynamic link library (DLL)). The DLL, for example, may store code that performs any of the system processing described above. While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. A system comprising:
a shaping table;
a feedback receiver; and
a controller in communication with the shaping table and the feedback receiver, the controller operable to:
obtain a transmit signal for transmission;
obtain a sensed signal from the feedback receiver, the sensed signal arising from transmission of the transmit signal;
determine a transformation to the transmit signal exhibited in the sensed signal; and
determine a modification to the shaping table after determining the transformation.

2. The system of claim 1, where the modification comprises a new input/output relationship for the shaping table.

3. The system of claim 1, where the transformation comprises a gain.

4. The system of claim 1, where the transformation comprises a rotation.

5. The system of claim 1, where the controller is operable to determine the transformation by determining a load angle and a load magnitude that results in the transformation.

6. The system of claim 5, where the controller is further operable to:
search a shaping table library, according to the load angle and magnitude, to determine the modification.

7. The system of claim 6, where the shaping table library comprises multiple individual shaping table input/output relationships.

8. The system of claim 6, where the shaping table library comprises multiple shaping table input/output relationships mapped to a search space that is parameterized by the load angle and magnitude.

9. A method comprising:
preparing a transmit signal for amplification with an amplifier for transmission through an antenna;
obtaining a sensed signal arising from transmission of the transmit signal;
determining a difference between the sensed signal and the transmit signal; and
in response to the difference, modifying operation of an envelope tracking power supply that provides power for the power amplifier.

10. The method of claim 9, where modifying operation comprises:
changing a shaping table that provides an envelope tracking signal input to the envelope tracking power supply.

11. The method of claim 9, where determining a difference comprises:
determining a load angle.

12. The method of claim 9, where determining a difference comprises:
determining a load magnitude.

13. The method of claim 9, where obtaining a sensed signal comprises:
obtaining the sensed signal with a directional coupler.

14. The method of claim 9, where obtaining a sensed signal comprises:
obtaining the sensed signal with a feedback receiver in communication with the antenna.

15. The method of claim 9, where determining a difference comprises:
determining a gain, a rotation, or both.

16. The method of claim 9, where modifying operation comprises:
obtaining a selected shaping table from a library of shaping tables; and
replacing an existing shaping table that provides an envelope tracking signal input to the envelope tracking power supply with the selected shaping table.

17. The method of claim 16, where determining a difference comprises:
determining a load angle and a load magnitude; and further comprising:
searching the library of shaping tables using load angle and load magnitude as search parameters.

18. A system comprising:
a baseband controller;
a shaping table in communication with the baseband controller, the shaping table operable to modify a transmit signal to provide envelope tracking signals characterized by a signal envelope;
an envelope tracking power supply operable to receive the envelope tracking signals and output a power supply voltage signal that approximates the signal envelope; and
a power amplifier operable to receive the power supply voltage signal and drive a transmit antenna; and
a feedback receiver coupled to the transmit antenna, where:
the baseband controller is operable to:
provide the transmit signal to the shaping table;
obtain, from the feedback receiver, sensed signal samples arising from transmission of the transmit signal through the transmit antenna;
analyze the sensed signal samples to determine a load angle and load magnitude affecting transmission of the transmit signal through the transmit antenna; and
adapt the shaping table to account for the load angle and the load magnitude.

19. The system of claim 19, where the baseband controller is operable to adapt the shaping table by:
replacing the shaping table with a different input/output relationship.

20. The system of claim 19, where the baseband controller is further operable to:
search a library of input/output relationships prepared for different load angles and load magnitudes, to locate the different input/output relationship.
